(19) United States
(12) Patent Application Publication
(10) Pub. No.: US 2010/0196775 A1
(43) Pub. Date: Aug. 5, 2010

(54) Heat Recycling System of Fuel Cells

(75) Inventors: Chi-Bin Wu, Taipei (TW); Feng-Chang Chen, Taipei (TW); Yu-Ming Sun, Taipei (TW); Seng-Woon Lim, Taipei (TW); Yenyu Chen, Taipei (TW)

Correspondence Address: Juan Carlos A. Marquez;c/o Stites & Harbison PLLC, 1199 North Fairfax Street, Suite 900, Alexandria, VA, 22314-1437, US

(73) Assignee: Chung-Hsin Electric and Machinery Manufacturing Corp., Jhonghe City (TW)

(21) Appl. No.: 12/396,508

(22) Filed: Mar. 3, 2009

Related U.S. Application Data
(60) Provisional application No. 61/129,479, filed on Jun. 30, 2008.

(51) Int. Cl. H01M 8/04

(52) U.S. Cl. 429/438; 429/434

(57) ABSTRACT

A heat recycling system of fuel cells is provided. The heat recycling system includes: a fuel cell apparatus, a cooling tank, an adsorption refrigerating apparatus, a first set of valve, and a second set of valve. The adsorption refrigerating apparatus has a first adsorption bed, a second adsorption bed, a first evaporator/condenser, and a second evaporator/condenser. The first set of valve connects the fuel cell apparatus and the cooling tank to the first adsorption bed and the second adsorption bed. The second set of valve connects the first evaporator/condenser and the second evaporator/condenser to the cooling tank. Switching of the first and the second sets of valve is controlled by an automatic control system communicating between the fuel cell apparatus, the cooling tank, and the adsorption refrigerating apparatus. Thus, waste heat generated by the fuel cell apparatus is timely brought away, recycled, and reused by the adsorption refrigerating apparatus.

### BACKGROUND OF THE INVENTION

1. Field of the Invention

The present invention relates to heat recycling systems of fuel cells and, more particularly, to a heat recycling system of fuel cells for use with the fuel cells.

2. Description of the Prior Art

A fuel cell apparatus is a power generation device whereby a fuel (for example, hydrogen, methanol, carbon monoxide, or hydrocarbons) reacts with an oxidizing agent (for example, oxygen) in electrochemical reaction so as to generate electric power.

Oxygen and hydrogen required for the fuel cell apparatus are provided by a cathode gas source and an anode gas source, respectively, and then the oxygen and the hydrogen undergo electrochemical reaction in the fuel cell apparatus so as to generate electric power. However, in addition to electric power, the electrochemical reaction taking place in the fuel cell apparatus produces a large amount of waste heat. The waste heat which originates in the fuel cell apparatus has to be removed therefrom, so as to keep the fuel cell apparatus at appropriate operating temperature lest the performance of the fuel cell apparatus is compromised.

In general, upon delivery of a cooling liquid to the fuel cell apparatus, the cooling liquid at relatively low temperature absorbs waste heat from the fuel cell apparatus before being discharged from the fuel cell apparatus together with the waste heat, so as to remove the waste heat from the fuel cell apparatus timely. However, the above-mentioned has a drawback, namely the cooling liquid has to be delivered to the fuel cell apparatus continually. Hence, there is an urgent need to devise a complete fuel cell system in which waste heat from a fuel cell apparatus can be timely removed.

### SUMMARY OF THE INVENTION

The present invention provides a heat recycling system of fuel cells wherein a fuel cell apparatus and a cooling tank are coupled to each other via an adsorption refrigerating apparatus so as to form a recycling system whereby waste heat generated by the fuel cell apparatus is timely removed therefrom and recycled for use as a heat source of the adsorption refrigerating apparatus.

The present invention provides a heat recycling system of fuel cells whereby a fuel cell apparatus is kept at an appropriate operating temperature favorable for electrochemical reaction.

The present invention provides a heat recycling system of fuel cells whereby integration of an adsorption refrigerating apparatus and an air conditioning apparatus enables electric power to be generated by the fuel cell apparatus and cool air to be produced concurrently.

To achieve the above and other objectives, the present invention provides a heat recycling system of fuel cells. The system comprises a fuel cell apparatus, a cooling tank, an adsorption refrigerating apparatus, a first set of valve, and a second set of valve. The adsorption refrigerating apparatus has a first chamber and a second chamber. The first chamber is provided with at least a first adsorption bed and a first evaporator/condenser therein. The second chamber is provided with at least a second adsorption bed and a second evaporator/condenser therein. The first set of valve is connected to the fuel cell apparatus, the cooling tank, the first adsorption bed, and the second adsorption bed. The second set of valve is connected to the cooling tank, the first evaporator/condenser, and the second evaporator/condenser.

The present invention involves at least the following inventive steps:

1. An adsorption refrigerating apparatus is coupled to a fuel cell apparatus and a cooling tank, so as to form a recycling system for recycling and reusing waste heat generated by the fuel cell apparatus.

2. An adsorption refrigerating apparatus is coupled to an air conditioning apparatus such that electric power is generated by the fuel cell apparatus and cool air is produced concurrently.

The following illustrative embodiments describe the features and advantages of the present invention in detail. After reading the disclosure of the specification, the claims, and the drawings, persons skilled in the art can readily comprehend the objectives and advantages of the present invention and implement the present invention.

### BRIEF DESCRIPTION OF THE DRAWINGS

FIG. 1 is a schematic view of a first preferred embodiment of a heat recycling system of fuel cells according to the present invention;

FIG. 2 is a schematic view of a second preferred embodiment of the heat recycling system of fuel cells according to the present invention;

FIG. 3 is a schematic view of a third preferred embodiment of the heat recycling system of fuel cells according to the present invention; and

FIG. 4 is a schematic view of a fourth preferred embodiment of the heat recycling system of fuel cells according to the present invention.

### DETAILED DESCRIPTION OF THE EMBODIMENTS

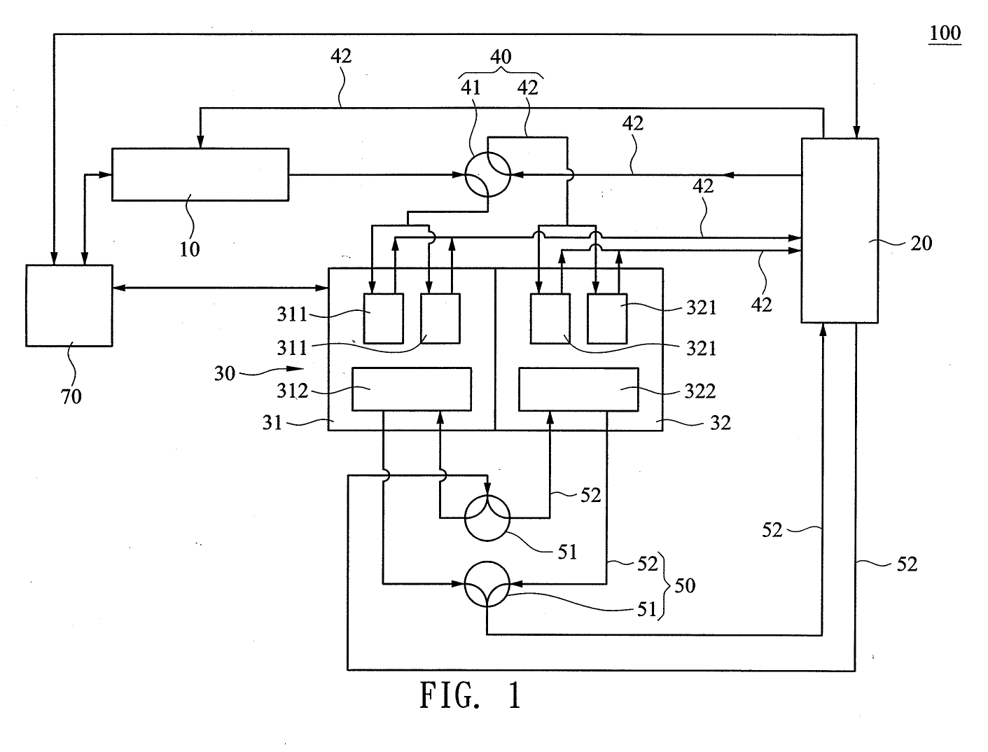

Referring to FIG. 1 through FIG. 4, in the present preferred embodiment, a heat recycling system 100, 100′ of fuel cells comprises a fuel cell apparatus 10, a cooling tank 20, an adsorption refrigerating apparatus 30, a first set of valve 40, and a second set of valve 50.

The fuel cell apparatus 10 is a water-cooled fuel cell apparatus or an oil-cooled fuel cell apparatus. The fuel cell apparatus 10 can be of several types according to the electrolyte used, namely a Proton Exchange Membrane Fuel Cell (PEMFC) device, an Alkaline Fuel Cell (AFC) device, a Phosphoric Acid Fuel Cell (PAFC) device, a Solid Oxide Fuel Cell (SOFC) device, or a Molten Carbonate Fuel Cell (MCFC) device, among others.

The cooling tank 20 stores a cooling liquid. The cooling liquid is cooling water or cooling oil. Since electrochemical reaction in the fuel cell apparatus 10 is exothermic, the cooling liquid is delivered from the cooling tank 20 to the fuel cell apparatus 10, such that waste heat generated from the fuel cell apparatus 10 is removed therefrom. Consequently, the operating temperature of the fuel cell apparatus 10 is maintained within an appropriate range.

The adsorption refrigerating apparatus 30 is a solid-state adsorption refrigerating apparatus. The adsorption refrigerating apparatus 30 has a first chamber 31 and a second chamber 32. The first chamber 31 and the second chamber 32 are vacuum chambers. The first chamber 31 is provided therein with at least a first adsorption bed 311 and a first evaporator/condenser 312. The second chamber 32 is provided therein with at least a second adsorption bed 321 and a second evaporator/condenser 322. Each of the first adsorption bed 311 and the second adsorption bed 321 is provided with an adsorbent and a coolant. The adsorbent is a porous material, such as silica gel, molecular sieve, active carbon, activated carbon fiber, calcium chloride, zeolite, foamed metal, or activated aluminum oxide, among others. The coolant is water, methanol, ethanol, or ammonia liquid, among others.

Alternatively, referring to FIG. 1 through FIG. 4, the adsorption refrigerating apparatus 30 has at least two said first adsorption beds 311 connected in parallel and at least two said second adsorption beds 321 connected in parallel.

The adsorption refrigerating apparatus 30 operates by interaction between the adsorbent and the coolant and effectuates cooling by evaporation and heat absorption, whose details are presented below.

At low temperature, the adsorbent in the first adsorption bed 311 or the second adsorption bed 321 adsorbs a large amount of the coolant and allows adsorption to take place. Heat is released whenever the adsorbent adsorbs the coolant, thereby raising the temperature of the cooling liquid passing the first adsorption bed 311 or the second adsorption bed 321. Afterward, the adsorbent saturated with the coolant is heated up by a heat source so as to release the coolant in gaseous form, that is, desorption. The adsorbent desorbs the coolant by absorbing heat. As a result, the temperature of the cooling liquid passing the first adsorption bed 311 or the second adsorption bed 321 is reduced.

While adsorption takes place, the first evaporator/condenser 312 or the second evaporator/condenser 322 functions as an evaporator whereby the coolant evaporates (i.e., the coolant is converted from liquid phase into gaseous phase); hence, heat energy of the cooling liquid passing the first evaporator/condenser 312 or the second evaporator/condenser 322 is absorbed so as to decrease the temperature of the cooling liquid, and in consequence cooling is effectuated. However, during desorption, the first evaporator/condenser 312 or the second evaporator/condenser 322 functions as a condenser whereby the coolant condenses (i.e., the coolant is converted from gaseous phase into liquid phase); hence, the cooling liquid passing the first evaporator/condenser 312 or the second evaporator/condenser 322 absorbs heat, and in consequence the temperature of the cooling liquid increases.

Therefore, desorption which takes place in the adsorption refrigerating apparatus 30 decreases the temperature of the cooling liquid passing the first adsorption bed 311 or the second adsorption bed 321 but increases the temperature of the cooling liquid passing the first evaporator/condenser 312 or the second evaporator/condenser 322. Conversely, adsorption which takes place in the adsorption refrigerating apparatus 30 increases the temperature of the cooling liquid passing the first adsorption bed 311 or the second adsorption bed 321 but decreases the temperature of the cooling liquid passing the first evaporator/condenser 312 or the second evaporator/condenser 322, and in consequence cooling is effectuated.

The first set of valve 40 comprises at least a switch valve 41 and a plurality of pipelines 42. The switch valve 41 and the pipelines 42 together enable the fuel cell apparatus 10, the cooling tank 20, the first adsorption bed 311, and the second adsorption bed 321 to be connected to one another. The switch valve 41 is a two-way valve, a three-way valve, a four-way valve, or a combination thereof, but is not limited thereto.

The second set of valve 50 comprises at least a switch valve 51 and a plurality of pipelines 52. The switch valves 51 and the pipelines 52 together enable the cooling tank 20, the first evaporator/condenser 312, and the second evaporator/condenser 322 to be connected to one another. The switch valve 51 is a two-way valve, a three-way valve, a four-way valve, or a combination thereof, but is not limited thereto.

As shown in FIGS. 1 through 4, in order to facilitate switching of the first set of valve 40 and of the second set of valve 50, the heat recycling system 100, 100′ of fuel cells further comprises an automatic control system 70 that communicates between the fuel cell apparatus 10, the cooling tank 20, and the adsorption refrigerating apparatus 30 for monitoring respective states of the fuel cell apparatus 10, the cooling tank 20, and the adsorption refrigerating apparatus 30, so as to control switching on/off of the first set of valve 40 and of the second set of valve 50.

As shown in FIG. 1, when both the first set of valve 40 and the second set of valve 50 are at a first state, the switch valves 41, 51 are at the first state, allowing the fuel cell apparatus 10 to communicate with the first adsorption bed 311 in the first chamber 31, the cooling tank 20 to communicate with the second adsorption bed 321 in the second chamber 32, and the cooling tank 20 to also communicate with the first evaporator/condenser 312 and the second evaporator/condenser 322.

Thus, the cooling liquid in the cooling tank 20 is guided through the fuel cell apparatus 10 by the pipelines 42 of the first set of valve 40, so that waste heat generated by the fuel cell apparatus 10 is removed therefrom by the cooling liquid and recycled for use as a heat source of the adsorption refrigerating apparatus 30.

The high-temperature cooling liquid from the fuel cell apparatus 10 passes the switch valve 41 at the first state and enters the first adsorption bed 311 in the first chamber 31, so as to enable desorption to take place in the first adsorption bed 311. Owing to desorption, the temperature of the cooling liquid introduced into the first adsorption bed 311 decreases. The low-temperature cooling liquid from the first adsorption bed 311 is guided back to the cooling tank 20 via the pipelines 42.

Meanwhile, the first evaporator/condenser 312 functions as the condenser. The cooling liquid in the cooling tank 20 passes one of the switch valves 51 and the pipelines 52 of the second set of valve 50 and enters the first evaporator/condenser 312 in the first chamber 31. As a result, the coolant desorbed from the first adsorption bed 311 is condensed (into liquid phase from gaseous phase) by the cooling liquid, and the temperature of the cooling liquid discharged from the first evaporator/condenser 312 increases. The cooling liquid discharged from the first evaporator/condenser 312 is guided back to the cooling tank 20 by another one of the switch valves 51 and the pipelines 52 of the second set of valve 50.

When both the first set of valve 40 and the second set of valve 50 are at the first state, the switch valve 41 and the pipelines 42 of the first set of valve 40 also guide the cooling liquid from the cooling tank 20 to the second chamber 32 of the adsorption refrigerating apparatus 30 so as to enable adsorption to take place in the second adsorption bed 321 in the second chamber 32 and thereby increase the temperature of the cooling liquid introduced into the second adsorption bed 321. The high-temperature cooling liquid discharged from the second adsorption bed 321 is guided back to the cooling tank 20 via the pipelines 42.

Meanwhile, the second evaporator/condenser 322 functions as the evaporator. The cooling liquid in the cooling tank 20 is guided into the second evaporator/condenser 322 in the second chamber 32 by one of the switch valves 51 and the pipelines 52 of the second set of valve 50. The second evaporator/condenser 322 absorbs heat to evaporate the coolant (i.e., into gaseous phase from liquid phase), thereby decreasing the temperature of the cooling liquid passing the second evaporator/condenser 322. The cooling liquid discharged from the second evaporator/condenser 322 returns to the cooling tank 20 via another one of the switch valves 51 and the pipelines 52 of the second set of valve 50.

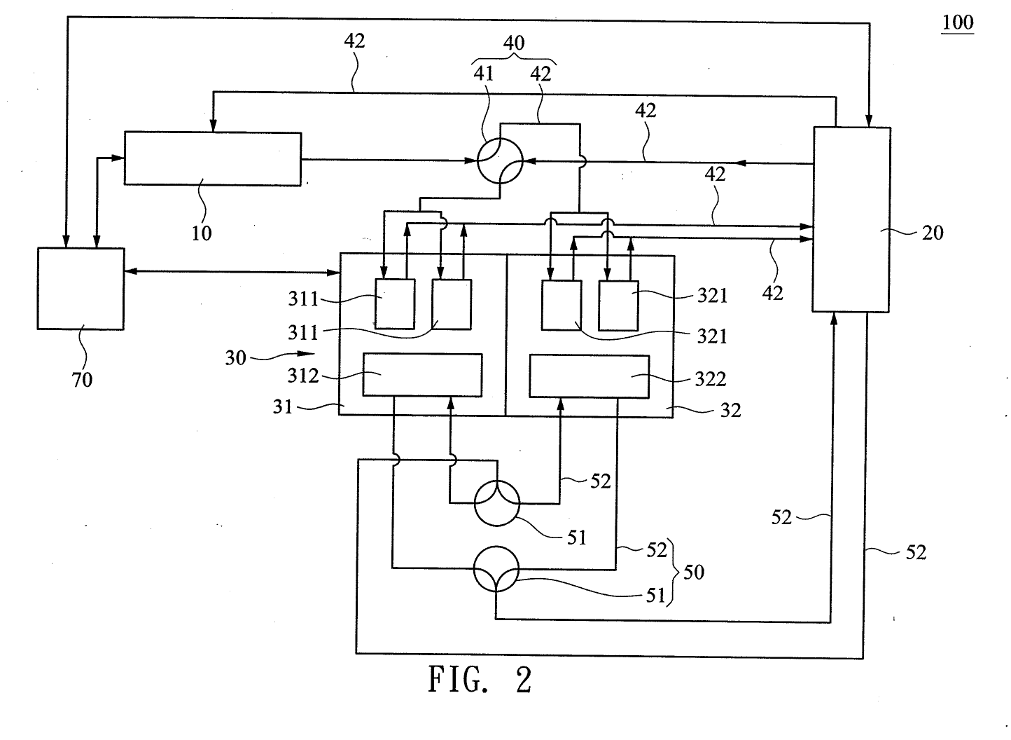

Referring to FIG. 2, upon completion of desorption in the first adsorption bed 311, the switch valve 41 of the first set of valve 40 is switched to a second state, so as to change the direction of flow of the cooling liquid and put the fuel cell apparatus 10 in communication with the second adsorption bed 321 in the second chamber 32, and the cooling tank 20 in communication with the first adsorption bed 311 in the first chamber 31.

Thus, the high-temperature cooling liquid from the fuel cell apparatus 10 enters the second adsorption bed 321 in the second chamber 32 to enable desorption to take place in the second adsorption bed 321. Meanwhile, the cooling liquid in the cooling tank 20 is guided to the first adsorption bed 311 in the first chamber 31 to enable adsorption to take place in the first adsorption bed 311. Hence, the first set of valve 40 is switched between different states to allow desorption and adsorption to alternate between the first adsorption bed 311 and the second adsorption bed 321, thereby maintaining the operating temperature of the fuel cell apparatus 10 within an appropriate range.

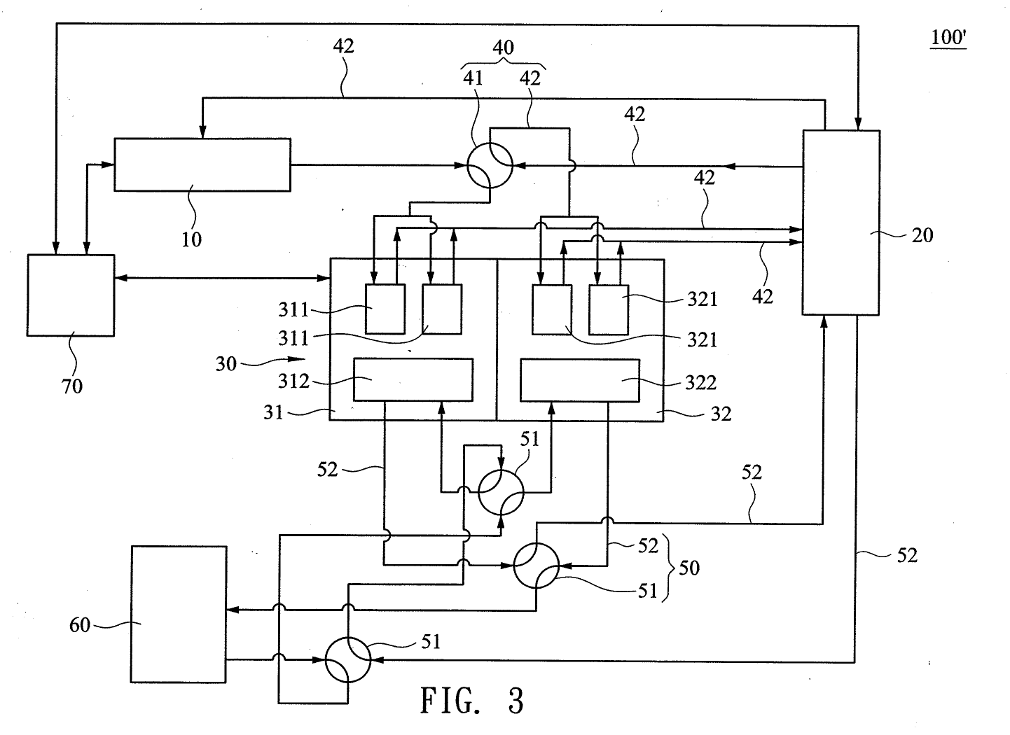

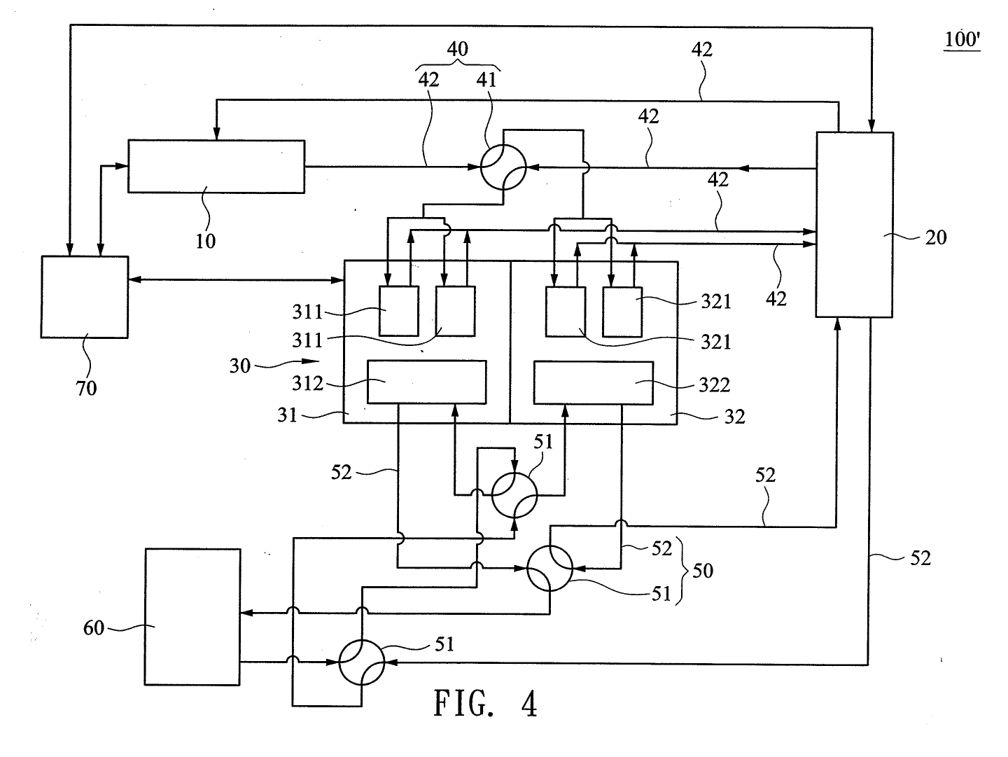

As shown in FIGS. 3 and 4, the heat recycling system 100′ of fuel cells further comprises an air conditioning apparatus 60 connected to the cooling tank 20, the first evaporator/condenser 312, and the second evaporator/condenser 322 by means of the second set of valve 50.

With the first evaporator/condenser 312 or the second evaporator/condenser 322 functioning as the evaporator, heat energy of the cooling liquid passing the first evaporator/condenser 312 or the second evaporator/condenser 322 is absorbed to enable the first adsorption bed 311 or the second adsorption bed 321 to desorb the coolant. Meanwhile, the temperature of the cooling liquid in the first evaporator/condenser 312 or the second evaporator/condenser 322 decreases to produce a cooling effect. Therefore, the low-temperature cooling liquid produced by the first evaporator/condenser 312 or the second evaporator/condenser 322 can be applied to the air conditioning apparatus 60.

Referring to FIG. 3, when the first set of valve 40 is at the first state, with the second evaporator/condenser 322 functioning as the evaporator, the switch valves 51 and the pipelines 52 of the second set of valve 50 together allow the air conditioning apparatus 60 to communicate with the second evaporator/condenser 322 in the second chamber 32. Accordingly, the low-temperature cooling liquid from the second evaporator/condenser 322 is guided into the air conditioning apparatus 60 and enables the air conditioning apparatus 60 to produce cool air. The cooling liquid is thus heated up and guided back to the cooling tank 20 through the switch valves 51 and the pipelines 52.

Referring to FIG. 4, when the second set of valve 50 is at the second state, with the switch valves 51 of the second set of valve 50 switched to the second state and the first evaporator/condenser 312 functioning as the evaporator, the air conditioning apparatus 60 is allowed to communicate with the first evaporator/condenser 312 in the first chamber 31. Thus, the low-temperature cooling liquid from the first evaporator/condenser 312 is guided into the air conditioning apparatus 60 and enables the air conditioning apparatus 60 to produce cooling air. The cooling liquid is thus heated up and guided back into the cooling tank 20 through the switch valves 51 and the pipelines 52.

The switch valves 51 of the second set of valve 50 is timely switched between different states according to the state of the first set of valve 40, so as to continually introduce the low-temperature cooling liquid from the first evaporator/condenser 312 or the second evaporator/condenser 322 into a low-temperature liquid circuit of the air conditioning apparatus 60. As a result, the air conditioning apparatus 60 continually uses the low-temperature cooling liquid provided by the adsorption refrigerating apparatus 30 to turn incoming hot air into cool air and delivers the cool air.

In conclusion, in the above-mentioned present preferred embodiments, the adsorption refrigerating apparatus 30 reduces the temperature of the cooling liquid discharged from the fuel cell apparatus 10 and guides the cooling liquid back to the cooling tank 20 so as to recycle the cooling liquid continually and thus maintain the operating temperature of the fuel cell apparatus 10 within an appropriate range. In addition, waste heat generated by the fuel cell apparatus 10 is recycled for use as a heat source of the adsorption refrigerating apparatus 30. Hence, the fuel cell apparatus 10 not only generates electric power but also works in conjunction with the adsorption refrigerating apparatus 30 and the air conditioning apparatus 60 to produce cool air, so that power generation and cool air production are effectuated concurrently.

The foregoing specific embodiments are only intended to describe the characteristics of the present invention and enable persons skilled in the art to gain insight into the disclosure of the present invention so as to implement the present invention. It is understood that the embodiments are not intended to restrict the scope of the present invention. Hence, all equivalent modifications and variations made in the foregoing embodiments without departing from the spirit and principle of the present invention as disclosed herein should fall within the scope of the appended claims.

What is claimed is:

1. A heat recycling system of fuel cells, comprising:
a fuel cell apparatus;
a cooling tank;
an adsorption refrigerating apparatus having a first chamber and a second chamber, the first chamber being provided with at least a first adsorption bed and a first evaporator/condenser therein, and the second chamber being provided with at least a second adsorption bed and a second evaporator/condenser therein;
a first set of valve connected to the fuel cell apparatus, the cooling tank, the first adsorption bed, and the second adsorption bed; and
a second set of valve connected to the cooling tank, the first evaporator/condenser, and the second evaporator/condenser.

2. The heat recycling system of claim 1, wherein the fuel cell apparatus is a water-cooled fuel cell apparatus or an oil-cooled fuel cell apparatus.

3. The heat recycling system of claim 1, wherein the first chamber and the second chamber are vacuum chambers.

4. The heat recycling system of claim 1, wherein each of the first adsorption bed and the second adsorption bed is provided with an adsorbent and a coolant.

5. The heat recycling system of claim 4, wherein the adsorbent is silica gel, molecular sieve, active carbon, activated carbon fiber, calcium chloride, zeolite, foamed metal, or activated aluminum oxide.

6. The heat recycling system of claim 4, wherein the coolant is water, methanol, ethanol, or ammonia liquid.

7. The heat recycling system of claim 1, wherein the adsorption refrigerating apparatus has at least two said first adsorption beds connected in parallel.

8. The heat recycling system of claim 1, wherein the adsorption refrigerating apparatus has at least two said second adsorption beds connected in parallel.

9. The heat recycling system of claim 1, wherein the first set of valve comprises at least a switch valve and a plurality of pipelines.

10. The heat recycling system of claim 9, wherein the switch valve is a two-way valve, a three-way valve, a four-way valve, or a combination thereof.

11. The heat recycling system of claim 1, wherein the second set of valve comprises at least a switch valve and a plurality of pipelines.

12. The heat recycling system of claim 11, wherein the switch valve is a two-way valve, a three-way valve, a four-way valve, or a combination thereof.

13. The heat recycling system of claim 1, further comprising an air conditioning apparatus connected to the cooling tank, the first evaporator/condenser, and the second evaporator/condenser via the second set of valve.

14. The heat recycling system of claim 1, further comprising an automatic control system that communicates between the fuel cell apparatus, the cooling tank, and the adsorption refrigerating apparatus so as to control switching of the first set of valve and of the second set of valve.
